(19) United States
(12) Patent Application Publication
(10) Pub. No.: US 2026/0231085 A1
(43) Pub. Date: Aug. 6, 2026

(54) DEVICES, METHODS, AND MEDIUM FOR COMMUNICATION

(71) Applicant: NEC Corporation, Tokyo (JP)

(72) Inventors: Wei CHEN, Beijing (CN); Zhen HE, Beijing (CN); Peng GUAN, Beijing (CN); Rao SHI, Beijing (CN); Gang WANG, Beijing (CN)

(73) Assignee: NEC Corporation, Tokyo (JP)

(21) Appl. No.: 19/149,320

(22) PCT Filed: Jan. 19, 2023
(86) PCT No.: PCT/CN2023/073214

§ 371 Date: Jul. 18, 2025

(51) Int. Cl. H04W 64/00; G06N 20/00; H04L 5/00; H04W 56/00

(52) U.S. Cl. CPC H04W 64/00; G06N 20/00; H04L 5/005; H04W 56/0035

(57) ABSTRACT

Example embodiments of the present disclosure relate to a solution for training dataset acquiring for an artificial intelligence/machine learning (AI/ML) model. In this solution, a first communication device transmits, to at least one second communication device, first information related to at least one training dataset with at least one data size for an impact factor that affects generalization capability of an AI/ML model. The first communication device acquires the at least one training dataset for training or fine-tuning the AI/ML model.

### FIELDS

Example embodiments of the present disclosure generally relate to the field of communication techniques and in particular, to devices, methods, and medium for training dataset acquiring for an artificial intelligence/machine learning (AI/ML) model.

### BACKGROUND

In the telecommunication industry, artificial intelligence/machine learning (AI/ML) models have been employed in telecommunication systems to improve the performance of telecommunications systems. For example, supporting various positioning mechanisms to provide reliable and accurate UE location has always been one of the key features of in the telecommunications systems. It has been agreed to investigate the potential for AI/ML in air interface to improve comprehensive performance in 5G-advanced. AI/ML based positioning mechanism to improve the positioning accuracy is one of the use cases to apply AI/ML in air interface. Works are on-going regarding how to ensure accuracy of output of the AI/ML model, in order to improve AI/ML based positioning accuracy.

### SUMMARY

In general, embodiments of the present disclosure provide devices, methods, and computer storage medium for training dataset acquiring for an artificial intelligence/machine learning (AI/ML) model.

In a first aspect, there is provided a first communication device. The device comprises a processor configured to cause the first communication device to: transmit, to at least one second communication device, first information related to at least one training dataset with at least one data size for an impact factor that affects generalization capability of an artificial intelligence/machine learning (AI/ML) model; and acquire the at least one training dataset for training or fine-tuning the AI/ML model.

In a second aspect, there is provided a second communication device. The device comprises a processor configured to cause the second communication device to: receive, from a first communication device, first information related to at least one training dataset with at least one data size for an impact factor that affects generalization capability of an artificial intelligence/machine learning (AI/ML) model; and cause the first communication device to acquire the at least one training dataset for training or fine-tuning the AI/ML model based on the first information.

In a third aspect, there is provided a communication method. The method comprises: transmitting, by a first communication device and to at least one second communication device, first information related to at least one training dataset with at least one data size for an impact factor that affects generalization capability of an artificial intelligence/machine learning (AI/ML) model; and acquiring the at least one training dataset for training or fine-tuning the AI/ML model.

In a fourth aspect, there is provided a communication method. The method comprises: receiving, by a second communication device and from a first communication device, first information related to at least one training dataset with at least one data size for an impact factor that affects generalization capability of an artificial intelligence/machine learning (AI/ML) model; and causing the first communication device to acquire the at least one training dataset for training or fine-tuning the AI/ML model based on the first information.

In a fifth aspect, there is provided a computer readable medium. The computer readable medium has instructions stored thereon, the instructions, when executed on at least one processor, causing the at least one processor to perform the method according to the third aspect or the fourth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a schematic diagram of lifecycle management of an AI/ML model in accordance with some embodiments of the present disclosure;

FIG. 3 illustrates a signaling flow for training dataset acquiring for an AI/ML model in accordance with some embodiments of the present disclosure;

FIG. 4A and FIG. 4B illustrate example signaling flows for training dataset acquiring for an AI/ML model in accordance with some embodiments of the present disclosure;

FIG. 5 illustrates an example showing a network synchronization error for transmission-reception pair (TPRs) in accordance with some embodiments of the present disclosure;

FIG. 6 illustrates an example workflow of training dataset acquiring for model finetuning in accordance with some embodiments of the present disclosure;

FIG. 7 illustrates a general trend between increased samples for fine-tuning the model and improvement of positioning accuracy in accordance with some embodiments of the present disclosure;

FIG. 8 illustrates a flowchart of a method implemented at a first communication device in accordance with some embodiments of the present disclosure;

FIG. 9 illustrates a flowchart of a method implemented at a second communication device in accordance with some embodiments of the present disclosure;

FIG. 10 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node.

The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the in output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the application stage, the resulting machine learning model may be used to process a real-world model input based on the set of parameter values obtained from the training process and to determine the corresponding model output.

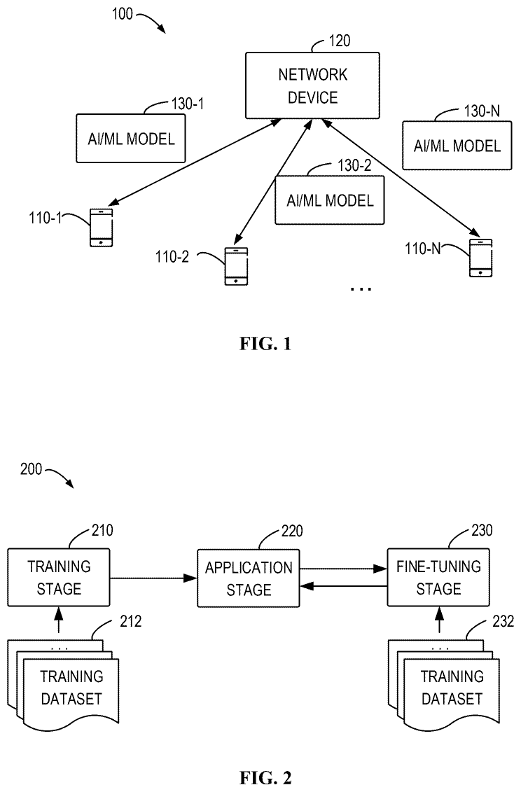

FIG. 1 illustrates a schematic diagram of an example communication environment 100 in which example embodiments of the present disclosure can be implemented. In the communication environment 100, a plurality of communication devices, including a terminal device 110-1, a terminal device 110-2, . . . , a terminal device 110-N and a network device 120, can communicate with each other. The terminal device 110-1, terminal device 110-2, . . . , and terminal device 110-N can be collectively or individually referred to as “terminal device(s) 110.” The number N can be any suitable integer number.

In the example of FIG. 1, a terminal device 110 may be a UE and the network device 120 may be a base station serving the UE. The serving area of the network device 120 may be called a cell (not shown). In the communication environment 100, the network device 120 and the terminal devices 110 may communicate data and control information to each other. In some examples, the network device 120 may comprise a core network device such as a location management function (LMF) or any other entity that stores the AI/ML model in a core network.

In some embodiments, one or more AI/ML models 130-1, 130-2, . . . , 130-N are trained and provided for use by respective terminal devices 110-1, 110-2, . . . , 110-N. The AI/ML models 130-1, 130-2, . . . , 130-N can be collectively or individually referred to as “AI/ML model(s) 130.” An AI/ML model 130 may be trained to implement a certain communication related function at a terminal device 110 or at a network device 120.

In some embodiments, the AI/ML models 130 may comprise AI/ML models for positioning of terminal devices 110. In some embodiments, an AI/ML model 130 may be a direct AI/ML positioning model. An input to the direct AI/ML positioning model may comprise information related to a channel between a terminal device 110 and a network device, such as Channel Impulse Response (CIR). The input may be collected by transmitting a reference signal, such as a positioning reference signal (PRS), a sounding reference signal (SRS), or a channel state information reference signal (CSI-RS) over the channel between the terminal device 110 and the network device. An output of the direct AI/ML positioning model may comprise a location of the terminal device 110.

In some embodiments, an AI/ML model 130 may be an AI/ML assisted positioning model. An input to the AI/ML assisted positioning model may comprise may be the same or similar to that of the direct AI/ML positioning model. An output of the AI/ML assisted positioning model may comprise intermediate results of location information for a terminal device 110. The intermediate results of the location information may include, but are not limited to, time of arrival (TOA), time difference of arrival (TDOA), non-line of slight (NLOS)/line of sight (LOS) identification of a channel, or the like. Such intermediate results may be used to assist in determining a location of the terminal device 110.

In the embodiments illustrated in FIG. 1, the AI/ML models 130 may be the same or different, and may be of the same type or different types of direct AI/ML positioning model and AI/ML assisted positioning model.

In some embodiments, an AI/ML model 130 may be trained at the network device 120 and then transferred to one or more suitable terminal devices 110 for use. In some embodiments, an AI/ML model 130 may be trained at a terminal device 110 and then applied locally or transferred to one or more other terminal devices 110 by a network device for use. It would be appreciated that the AI/ML model 130 may be trained and/or transferred by any other entity in the communication environment 100.

FIG. 2 illustrates a schematic diagram of lifecycle management of an AI/ML model 130. At a training stage 210, one or more training datasets 212 are used to train an AI/ML model 130, for example, at the network device 120 or the terminal device 110. A training dataset 212 generally comprises inputs of the AI/ML model 130 and ground-truth labels for the corresponding inputs.

At an application stage 220, the trained AI/ML model 130 is provided to process actual inputs. For example, in the positioning scenario, the trained AI/ML model 130 is provided to the terminal device 110 to determine its location or intermediate results of location information (depending on the type of the AI/ML model 130). During the application stage, the performance of the AI/ML model 130 may be monitored. In some situations, if the AI/ML model 130 is deteriorating, the outputs for AI/ML-based positioning and AI/ML-assisted positioning may become inaccurate. For example, if the environment of the terminal device changes, the AI/ML model 130 may no longer output an accurate positioning result or intermediate measurements for the terminal device located in the changed environment. In this case, the AI/ML model 130 may be fine-tuned with one or more further training datasets 232 in a fine-tuning stage 230. The fine-tuning of the AI/ML model 130 may be implemented at the device who applies the AI/ML model to infer. The fine-tuned AI/ML model 130 may then be applied for future use.

Regarding collection of training data for AI/ML based positioning, for direct AI/ML positioning, the ground-truth label is a location of a terminal device. Several entities and mechanisms may be utilized to generate the ground-truth labels. For example, a PRU with known location may collect a data sample including an input to the model and the corresponding ground-truth location. Alternatively, or in addition, a UE may generate its location based on non-NR and/or NR RAT-dependent positioning methods. Alternatively, or in addition, a network device (e.g., LMF) may generate a location of a terminal device based on the positioning methods, or a LMF may know a location of a PRU.

For AI/ML assisted positioning, the ground-truth label is one or more of intermediate parameters corresponding to an output of the AI/ML model. Several entities and mechanisms may be utilized to generate the ground-truth labels. For example, a PRU may generate the label directly or calculates the label based on measurement or its location. A UE may generate the label directly or calculates the label based on measurement or its location. Alternatively, or in addition, a network device may generate the label directly or calculates the label based on measurement or its location.

As used herein, the term “AI/ML model” may be interchangeably with the term “model”. The term “AI/ML model training” may refer to a process to train an AI/ML model for example by learning the input/output relationship and obtained the several features from the input/output for inference. The term “model monitoring” used herein may refer to a procedure that monitors the inference performance of the AI/ML model.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell, and one or more additional cells may be deployed in the communication environment 100. It is noted that although illustrated as a network device, the network device 120 may be another device than a network device. Although illustrated as a terminal device, the terminal device 110 may be other device than a terminal device, such as a positioning reference unit (PRU).

In the following, for the purpose of illustration, some embodiments are described with the terminal device 110 operating as a UE and the network device 120 operating as a base station. However, in some embodiments, operations described in connection with a terminal device may be implemented at a network device or other device, and operations described in connection with a network device may be implemented at a terminal device or other device.

In some embodiments, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

An AM/ML model is a data driven method which learns the features from a large amount of data and infers the positioning or intermediate results based on the learnt features. Thus, the choice of training datasets used for training and fine-tuning the model are important. The AI/ML models for different usage may have different impact factors that affect the model generalization capabilities. For example, regarding the model generalization for positioning use case, it focuses on the impact factors of different drops, clutter parameters, network synchronization error, and scenario. It has be proved that mixed training datasets from different drops, clutter parameters, network synchronization errors, or scenarios for training the AI/ML model can improve the positioning accuracy. In addition, the mixed training datasets can also be used for retraining or fine-tuning to overcome the deterioration of positioning performance.

The positioning accuracy of the AI/ML model can be improved by a suitable training dataset. Thus, it is better to collect more field data with various cases for model training and fine-tuning when the cost of data collection is not considered, and the field data is always available. However, for a data-restricted scenario, it may need to determine many field data samples are required to conduct model training and fine-tuning, especially considering the different impact from different factors. When applying the AI/ML model to the wireless communication network for positioning purpose, an information interaction is needed to assist the involved entities (e.g., UE, PRU, gNB, LMF or the like) to collect a suitable and “balanced” training dataset from other entities where the dataset is transferred in physical layer or high layer.

However, in the communication environment, it is still unknown how to determine the mixed training samples from different impact factors to further improve the positioning accuracy, and the sizes of training datasets for different impact factors required to conduct model training and fine-tuning.

According to example embodiments of the present disclosure, there is provided an improved solution for training dataset acquiring for an AI/ML model. In this solution, a first communication device, which implements training or fine-tuning of an AI/ML model, transmits to one or more second communication devices information related to at least one training dataset with at least one data size for an impact factor that affects generalization capability of the AI/ML model. The information can be used for generating or assist in generating the at least one training dataset with the specified data size. With the guidance of the information, the second communication device(s) can collect or assist the first communication device in collecting the required training dataset(s). Through the solution, the model accuracy can be increased by the mixed training data that improves generalization performance and the training data generation/transfer related overhead can be decreased by the information interaction.

Example embodiments of the present disclosure will be described in detail below.

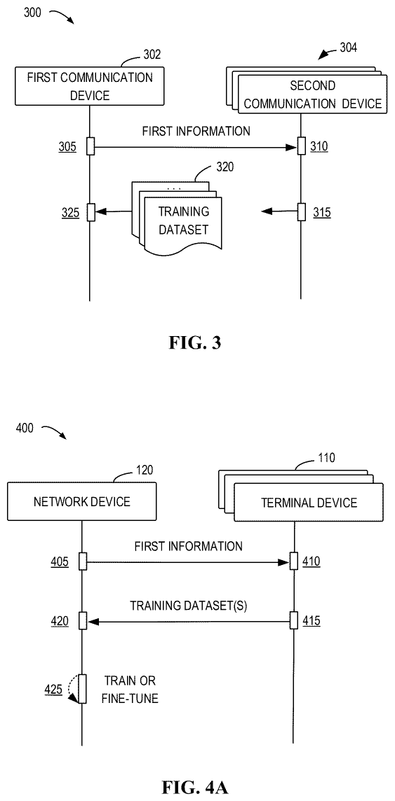

FIG. 3 illustrates a signaling flow 300 for training dataset acquiring for an AI/ML model in accordance with some embodiments of the present disclosure. As shown in FIG. 3, the signaling flow 300 involves a first communication device 302 and one or more second communication devices 304.

In the signaling flow 300, it is assumed that training and/or fine-tuning of an AI/ML model 130 is implemented at the first communication device 302. The second communication device(s) 304 is configured to collect and/or assist in collecting one or more training dataset(s) for the AI/ML model 130. As will be further discussed below, in some embodiments, the first communication device 302 may comprise a network device 120 and the second communication device(s) 304 may comprise one or more terminal device(s) 110 (e.g., UEs and/or PRUs) in the communication environment 100. In some embodiments, the first communication device 302 may comprise a terminal device 110, and the second communication device 304 may comprise the network device 120.

It is to be understood that the signaling flow 300 may involves more devices or less devices, and the number of devices illustrated in FIG. 3 is only for the purpose of illustration without suggesting any limitations.

In the signaling flow 300, the first communication device 302 transmits 305, to at least one second communication device 304, first information related to at least one training dataset with at least one data size for an impact factor that affects generalization capability of an AI/ML model. The first information is used to generate or assist in generating the at least one training dataset for each impact factor that affects the model generalization capability with a specific data size for training or fine-tuning the AI/ML model.

In some embodiments, the AI/ML model may comprise an AI/ML model for positioning, including a direct AI/ML positioning model or an AI/ML assisted positioning model. In the following embodiments, the AI/ML model for positioning is described for the purpose of illustration.

The impact factor that affects the generalization capability of the AI/ML model for positioning may comprise a drop, a clutter parameter, a scenario where the AI/ML model is implemented, or a network synchronization error.

The concept of different drops means different distributions of large-scale parameters in system level simulation. These large-scale parameters contain absolute time of arrival, angle of arrival, angle of departure, power of LOS/NLOS paths, initial phase of LOS/NLOS paths, delay of LOS/NLOS paths, and so on. For the case of the Indoor Factory (InF) scenario, different drops can be intuitively viewed as different factories with different interiors.

The concept of different clutter parameters means different kinds of clutter parameters {density, height, size} in the Indoor Factory with Dense clutter and High base station height (InF-DH) scenario, e.g., {60%, 6m, 2m}, {40%, 2m, 2m}, and so on. The most direct impact of different clutter parameters for positioning is that will result in the different probability of LOS/NLOS.

The concept of different scenarios focuses on factory halls of varying sizes and with varying levels of density of clutter, e.g., machinery, assembly lines, storage shelves (e.g., in the InF scenario). Example scenarios may include Indoor Factory with Sparse clutter and Low base station height (InF-SL) scenario, Indoor Factory with Dense clutter and Low base station height (InF-DL) scenario, Indoor Factory with Sparse clutter and High base station height (InF-SH) scenario, and the InF-DH scenario. Other scenarios where device positionings are needed may also be defined. Different scenarios may result in different probabilities of LOS/NLOS.

A network synchronization error may be caused by hardware imperfection or clock drift, which is an imperfect factor affecting the generalization performance of the AI/ML model. The network synchronization error can directly impair the feature of first-path delay, and it is unavoidable and difficult to eliminate completely. When a terminal device experiences different transmission and receiving (TRX) pairs, it may experiences different network synchronization errors. Thus, it is beneficial to evaluate its impact on positioning performance for AI/ML based positioning.

Some example impact factors are provided above. It would be appreciated that other impact factors which may affect the generalization capability of the AI/ML model may also be taken into account.

A training dataset for an impact factor may comprise training data samples collected in an environment of the impact factor. A data size of a training dataset may be measured by the number of data samples included in the training dataset. A data sample may include an input to the AI/ML model and a ground-truth output of the corresponding input. For the positioning use case, the input may include channel related information, such as CIR, obtained by detecting a reference signal. The ground-truth output may include a ground-truth location of the terminal device (for direct AI/ML positioning) or ground-truth intermediate results of location information (for AI/ML assisted positioning).

AI/ML model generalization performance is greatly important for actual model deployment. Evaluations have shown that positioning performance of AI/ML based positioning degrades when the model is trained by the dataset with one drop, clutter parameter, network synchronization error, or scenario, and is tested by the dataset with other drops, clutter parameters, network synchronization errors, or scenarios. The simulation also shows that training the AI/ML model with mixed training data is an effective way to improve the model generalization performance. Besides, fine-tuning can be used to improve the generalization performance. Further, the performance gain of model fine-tuning is clearly different for different impact factors that affect the generalization capability even if fine-tuning with the same scale of field training data. When the source domain and the target domain are greatly similar, fine-tuning the AI/ML model with a small amount of field data can approach ideal positioning performance.

The positioning accuracy is degraded if training data from one impact factor (e.g., a drop, a clutter parameter, a scenario or a network synchronization error), and test data from other impact factors (e.g., other drops, clutter parameters, scenarios or network synchronization errors). For the aspect of model generalization, the evaluation results have shown that on top of the dataset with a large scale of mixed samples from different drops, clutter parameters, network synchronization errors or scenarios, the positioning accuracy will be largely improved.

For a single type of impact factor (e.g., the drop, clutter parameter, network synchronization error, or scenario), training data with different mixed ratio (e.g., 60% of Drop 1 mixed with 40% of Drop 2 or 80% of Drop 1 mixed with 20% of Drop 2) for training the model will impact model generalization capability. For the overall factors, mixed training data with different factors for training the model have diverse impact for model generalization capability, e.g., mixed training data with different drops is more apparent than the mixed training data with different scenarios.

Fine-tuning the AI/ML model with a small amount of field data can approach ideal positioning performance, such as different drops. For the aspect of fine-tuning, the evaluation results have shown that fine-tuning the model with small amounts of samples from an unseen environment can achieve significant positioning accuracy improvement. For example, if the pre-trained AI/ML model is transferred to a new environment with a different clutter parameter, fine-tuning the AI/ML model with the new clutter parameter can improve positioning accuracy by at least 50%. With the increasing number of field data used for model fine-tuning, the positioning accuracy of AI/ML model continues to improve, but the effect may not be obvious.

Therefore, to improve the positioning accuracy and overcome the deterioration of positioning performance, it is desired to utilize mixed training datasets of different impact factors for retraining or fine-tuning of the AI/ML model. The data size of training dataset for a certain impact factor may be interacted among the related entities in a suitable way, to avoid high and unnecessary overhead for data transfer.

At the side of the first communication device 302 which implements the training or fine-tuning of the AI/ML model 130, it may not be able to collect mixed training datasets of different impact factors itself. Mixed training datasets of different impact factors may for example include mixed training datasets of different drops, mixed training datasets of different clutter parameters, mixed training datasets of different scenarios, or mixed training datasets of different network synchronization errors. The first communication device 302 thus can provide first information to determine or assist in determining the data size(s) of the training dataset(s) for other impact factors to conduct model training and fine-tuning.

A training dataset with a certain data size for a certain impact factor may correspond to an environment of the impact factor. Different impact factors may correspond to different environments to be experienced by the devices at which the AI/ML model is applied. For example, the drop factor may be defined with different drop levels, e.g., Drop 1, Drop 2, Drop 3, and so on. The impact factor of clutter parameters may be defined with different values for {density, height, size} in a certain scenario, such as {60%, 6m, 2m}, {40%, 2m, 2m}, and so on. The impact factor of scenarios may be defined with InF-DH scenario, InF-SH scenario, InF-SL scenario, InF-DL scenario, and so on. The impact factor of network synchronization errors may be defined with zero error or any suitable errors occurred in communication systems.

The at least one second communication device 304 receives 310 the first information and causes 315, based on the received first information, the first communication device 302 to acquire the at least one training dataset for training or fine-tuning the AI/ML model. The first communication device 302 thus acquires 325 the at least one training dataset 320 for training or fine-tuning the AI/ML model.

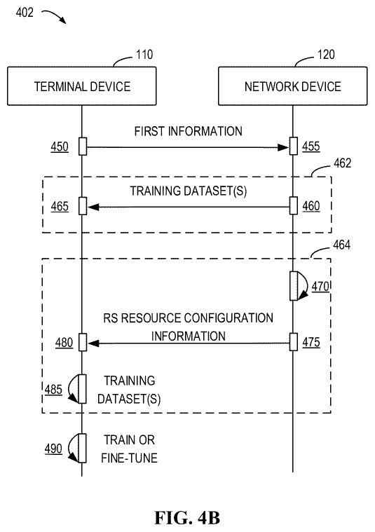

Depending on whether the first communication device 302 is a terminal device 110 or the network device 120, the first information may be different, and the acquiring of the training dataset(s) may also be different. Example embodiments will be discussed with reference to FIG. 4A and FIG. 4B.

FIG. 4A illustrates an example signaling flow 400 for training dataset acquiring for an AI/ML model in accordance with some embodiments of the present disclosure. In the embodiments of FIG. 4A, the first communication device 302 is a network device 120 for training or fine-tuning the AI/ML model, and the at least one second communication device 304 are a plurality of terminal devices 110 for collecting training datasets in the communication environment 100.

In the signaling flow 400, the network device 120 transmits 405, to the plurality of terminal devices 110, first information related to at least one training dataset with at least one data size for an impact factor that affects generalization capability of the AI/ML model.

In some embodiments, the plurality of terminal devices 110 may include different UEs and/or PRUs. In some embodiments, if a plurality of training datasets for different impact factors are to be acquired (e.g., different drops, different clutter parameters, or different scenarios), the plurality of terminal devices 110 may be distributed in different environments of the different impact factors.

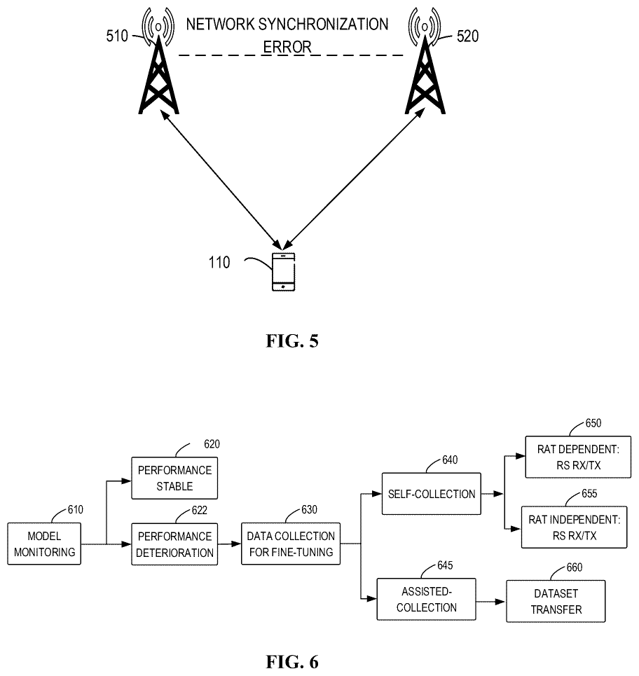

In some embodiments, for the impact factor of network synchronization error, it is caused by hardware imperfection or clock drift between different TRP pairs. For example, as illustrated in FIG. 6, a terminal device 110 and a network device 510 may be a TRP pair, and the terminal device 110 and a network device 520 may be another TRP pair. In this case, there may be a network synchronization error between the two TRP pairs. If the model training or fine-tuning is implemented at the network side, the network device 120 may indicate a plurality of terminal devices 110 (UEs and/or/PRUs with different TRP pairs) to obtain training datasets for different network synchronization errors.

In some embodiments, if the network device 120 can assess the model performance by the priori data, e.g., how to mix training data from different impact factors to make the AI/ML model 130 have the expected generalization capability in a period of time, the network device 120 can indicate the plurality of terminal devices 110 to further generate or assist to generate the suitable training datasets from the different impact factors. The network device 120 may indicate the individual terminal device 110 to generate or assist to generate the mixed samples by assistance signaling/procedure of:

In some embodiments, the network device 120 may indicate an individual terminal device 110 to generate or assist to generate a minimum data size of a training dataset to be collected within a specific duration. The first information transmitted to the individual terminal device 110 may indicate a minimum data size of a training dataset to be collected within a specific duration when the terminal device 110 is believed to experience the corresponding impact factor.

In some embodiments, if the network device 120 determines that an individual terminal device 110 is to experience different environments of the impact factor within a plurality of durations, the network device 120 may indicate the individual terminal device 110 to generate or assist to generate a plurality of training datasets with a plurality of minimum data sizes to be collected during the plurality of durations. In those embodiments, the first information transmitted to the individual terminal device 110 may indicate a plurality of minimum data sizes of a plurality of training datasets to be collected and the plurality of durations during which the plurality of training datasets are to be collected, respectively.

For example, if the network device 120 determines that an individual terminal device 110 will experience different drops (e.g., different distributions of large-scale parameters, including path losses, penetration losses and shadow fading), or different clutter parameters in the InF-DH scenario, or different scenarios, the network device 120 may indicate the individual terminal device 110 to generate or assist to generate a plurality of training datasets with a plurality of minimum data sizes to be collected for different impact factors during the plurality of durations, e.g., {Number of sample1, Duration1; Number of sample2, Duration2, . . . }. In some examples, if the network device 120 determines that an individual terminal device 110 will experience different TRP pairs, e.g., the terminal device 110 is moving, it means that this terminal device 110 can experience different network synchronization errors within different durations. In this case, the network device 120 may indicate the individual terminal device 110 to generate or assist to generate a plurality of training datasets with a plurality of minimum data sizes to be collected for different network synchronization errors, e.g., {Number of sample1, Duration1; Number of sample2, Duration2, . . . }.

The plurality of terminal devices 110 receives 410 the first information and transmits 415, to the network device 120, the plurality of training datasets or related information for generating the plurality of training datasets. The related information may include measurements or intermediate results of location information, which may be used by the network device 120 to determine ground-truth labels for the training datasets.

The network device 120 receives 420, from the plurality of terminal devices 110, the plurality of training datasets or the related information for generating the plurality of training datasets. In the embodiments where the related information is received, the network device 120 may generate the plurality of training datasets based on the received related information. In some embodiments, with the plurality of training datasets for different impact factors are received and/or generated, the network device 120 may train or fine-tune 425 the AI/ML model 130 with the plurality of training datasets.

FIG. 4B illustrates an example signaling flow 402 for training dataset acquiring for an AI/ML model in accordance with some embodiments of the present disclosure. In the embodiments of FIG. 4B, the first communication device 302 is a terminal device 110 for training or fine-tuning the AI/ML model, and the second communication device 304 is a network device 120 in the communication environment 100.

In the signaling flow 402, the terminal device 110 transmits 450, to the network device 120, first information related to at least one training dataset with at least one data size for an impact factor that affects generalization capability of the AI/ML model. The network device 120 receives 455 the first information and can provide or assist to provide the at least one training dataset for the terminal device 110. In a first approach 462, the network device 120 may determine, based on the first information, a data size of a training dataset to be acquired by the terminal device 110 and the impact factor related to the training dataset. Then the network device 120 may generate and/or collect the at least one training dataset and transmits 460 the at least one training dataset to the terminal device 110. The terminal device 110 receives 465 the at least one training dataset for training or fine-tuning 490 the AI/ML model.

In a second approach 464, the network device 120 determines 470 reference signal (RS) resource configuration information for the terminal device 110 based on the received first information. The network device 120 transmits 475 the RS resource configuration information to the terminal device 110. Upon receipt 480 of the RS resource configuration information, the terminal device 110 collects 485 the at least one training dataset based on the RS resource configuration information. The terminal device 110 may then train or fine-tune 490 the AI/ML model 130 with the received or collected training dataset(s).

Generally, if the model training and/or fine-tuning at the side of the terminal device, an individual terminal device may generally obtain training samples from one impact factor (e.g., one drop, clutter parameter, scenario or network synchronization error). The terminal device 110 may rely on the network device 120 to obtain training samples from other impact factor(s) (e.g., other drops, clutter parameters, scenarios or network synchronization errors) if the physical environment of the terminal device 110 is almost unchanged.

In some embodiments, if the terminal device 110 can assess the model performance by the priori data, e.g., how to mix data from different impact factors to make the AI/ML model have the expected generalization capability in a period of time, the terminal device 110 can request the network device 120 to further obtain or assist to generate a specific number of samples of other impact factors (e.g., from other UEs/PRUs in the same factories, from other UEs/PRUs in the different factories, from other UEs/PRUs in other scenarios) in a specific duration for online or offline training or fine-tuning. In such embodiments, the first information transmitted to the network device 120 may explicitly indicate the at least one data size of the at least one training dataset to be acquired, where the at least one data size corresponds to at least one environment of the impact factor. For example, the first information may indicate {Drop1, Num. 1}, {Drop2, Num.2}, . . . , {DropN, Num. N} for the impact factor of drops. As another example, the first information may indicate {Clutter parameter1, Num.1}, {Clutter parameter2, Num.2}, . . . , {Clutter parameterN, Num.N} for the impact factor of clutter parameters. Similar information may be indicated for other types of impact factors, such as the scenarios and network synchronization errors.

In some embodiments, the terminal device 110 may provide the first information for the network device 120 to determine the at least one data size of the at least one training dataset to be acquired. In some embodiments, the first information may indicate a data size of an available training dataset at the terminal device 110. That is, the terminal device 110 may report the data size of the training dataset for the current impact factor (e.g., the current drop, clutter parameter, scenario, or network synchronization error) and let the network device 120 to determine a data size(s) of a training dataset(s) for other different impact factors (e.g., other drops, clutter parameters, scenarios, or network synchronization errors). The data size(s) and the other different impact factors may be determined by the network device 120 based on predefined rules and/or other criteria.

In some embodiments, the first information may indicate RS resource configuration information used by the terminal device 110 to collect the available training dataset. To collect a training dataset by the terminal device 110, a reference signal (e.g., PRS or SRS) may be detected and measurements of the reference signal are collected. The RS resource configuration information may indicate a RS resource(s) configured for the terminal device 110.

With the RS resource configuration information used by the terminal device 110, the network device 120 may be able to determine the data size of the available training dataset at the terminal device 110. The network device 120 may then determine, based on the size of the available training dataset, a data size(s) of a training dataset(s) for other different impact factors (e.g., other drops, clutter parameters, scenarios, or network synchronization errors). The data size(s) and the other different impact factors may be determined by the network device 120 based on predefined rules and/or other criteria.

In some embodiments, regarding the impact factor of network synchronization error, since the terminal device 110 can only obtains the training samples with only one synchronization error or with zero synchronization error directly, the terminal device 110 can request the network device 120 to generate or assist to collect training datasets with other synchronization errors. The terminal device 110 may transit the first information indicating information related to a network synchronization error at the terminal device 110. The related information may directly indicate the network synchronization error at the terminal device 110, or the TRP pair(s) where the terminal device 110 is involved so that the network device 120 can determine the network synchronization error related to the TRP pair(s).

In some embodiments, the first information may indicate the number of basic training datasets to be acquired and a minimum data size of each basic training dataset. The minimum data size may be a group granularity for providing a basic training dataset for training or fine-tuning the AI/ML model. With the first information, the network device 120 may transmit respective basic training dataset(s) one by one. The terminal device 110 may thus receive from the network device 120 at least one basic training dataset with the minimum data size indicated by the first information. The terminal device 110 may train or fine-tune the AI/ML model based on the received basic training dataset(s).

If the terminal device 110 determines that the received training data is enough, for example, the trained or fine-tuned AI/ML model reaches a target accuracy level, the terminal device 110 may transmit, to the network device 120, a request to interrupt transmission of remaining basic training datasets. In response to the request, the network device 120 may prevent the remaining basic training datasets to be transmitted to the terminal device 110. In this case, the transmission overhead between the terminal device 110 and the network device 120 can be reduced.

The indication of the number of basic training datasets to be acquired and the minimum data size for the basic training dataset is especially beneficial for the case of model fine-tuning. FIG. 6 illustrates an example workflow of training dataset acquiring for model finetuning in accordance with some embodiments of the present disclosure. As illustrated, after the AI/ML model 130 is applied at the terminal device 110 in-field, a stage of model monitoring 610 starts, to monitor model performance. If the performance is stable at 620, no further actions on the AI/ML model 130 are needed. If the performance is deteriorating at 622, a stage of data collection 630 is initiated, to collect a training dataset(s) for fine-tuning the AI/ML model 130.

The data collection may include self-collection 640 by the terminal device 110, which may involve a RAT dependent method 650 for transmitting and receiving reference signals, and a RAT independent method 655 to determine locations by other positioning systems, such as Global Navigation Satellite System (GNSS). The data collection may include assisted-collection 645 which may involve dataset transfer 660 from other entity such as the network device 120.

The trained AI/ML model can be fine-tuned through a small amount of data to obtain an updated model, which is suitable for the current scene can further improve the AI/ML based positioning performance. It is obvious that the positioning accuracy of AI/ML model improve as the increased number of the field data used for model fine-tuning. However, with the continue linear increase of the fine-tuning samples, the improvement of positioning accuracy will certainly slow. FIG. 7 illustrates a general trend 700 between increased samples for fine-tuning the model and improvement of positioning accuracy. Therefore, an information interaction between the entities for sample generation and entity for model training/inference (also for fine-tuning) is important to trade off reliability of positioning (enough samples) and overhead of data generation/transfer (less sample) if the two entities are not the same.

For both self-collection and assisted-collection in model fine-tuning, the entity for implementing fine-tuning (i.e., the terminal device 110) may report the data size for fine-tuning. However, this entity may not clear how many samples from the current scene are suitable for fine-tuning the model. In some embodiments as mentioned above, the terminal device 110 may indicate in the first information the number of basic training datasets to be acquired and a minimum data size of each basic.

For dataset transfer in assisted-collection, the terminal device 110 may report the number of basic training datasets to be acquired and a minimum data size of each basic training dataset to the network device 120. The terminal device 110 may receive the basic training datasets one by one afterwards. Until the model retrain/fine-tuning is completed (e.g., the positioning accuracy improved to a specific level), the terminal device 110 can request to interrupt the data transfer for the following datasets.

For RAT dependent data collection, the terminal device 110 may report the number of basic training datasets to be acquired and a minimum data size of each basic training dataset when triggers the positioning in a Location Service Request signaling. The network device 120 (e.g., a LMF) may determine RS configuration information according to the number of basic training datasets and the minimum data size. Other entities, such as a base station, the terminal device 110, and/or other terminal devices 110 may cooperate according to the RS configuration information, to collect the number of basic training datasets with the indicated minimum data size.

In some embodiments, if the impact factor comprises a network synchronization error, the terminal device 110 may transmit, to the network device 120, the first information to indicate a request for statistical information of the network synchronization error. The current evaluation order the network synchronization error with 2 ns, 10 ns and 50 ns mostly. However the network synchronization error can be any of value in the specific range. Thus, the terminal device 110 may request statistical information of network synchronization error by a specific signaling from the network to generate the training samples at the side of the terminal device 110. Upon receipt of the request, the network device 120 may transmit the statistical information of the network synchronization error to the terminal device 110. The statistical information may include the values of mean and variance of the network synchronization error (if the synchronization error follows the normal distribution). The statistical information of synchronization error is used to fit the training dataset indirectly by assessing it from a plurality of terminal devices (UEs and/or PRUs). With the statistical information, the terminal device 110 may generate the at least one training dataset based on the statistical information of the network synchronization error.

In some embodiments, the network device 120 may provide information indicating expected data sizes of training datasets required to meet certain performance of the AI/ML model 130. In some embodiments, the network device 120 may be the entity which trains the AI/ML model 130. The network device 120 may determine the expected data sizes of training datasets required to meet certain performance of the AI/ML model 130 before transferring the AI/ML model to be applied at the terminal device 110. The terminal device 110 can thus determine the data sizes of training datasets for fine-tuning the AI/ML model 130 to achieve the certain performance.

Specifically, the network device 120 may transmit, to the terminal device 110, second information indicating a first expected size (e.g., N1) of a training dataset required to meet an expected positioning accuracy level of the AI/ML model, and/or a second expected size (e.g., N2) of a training dataset required to meet an expected positioning accuracy boosting rate of the AI/ML model.

In some embodiments, the first expected size N1 may meet the condition of

$${min}_{N 1} {f}_{1} ( N 1 ) \leq P ,$$

where f₁(x) is the function between a data size of a training dataset (for a specific impact factor that affects the model generalization capability, e.g., drops, clutter parameters, scenarios or synchronization errors) and the positioning requirements, and P is the expected positioning accuracy level (e.g., 1 m@99% in the horizontal direction for augmented reality technology in a smart factory scenario). In some embodiments, an upper limit for N1 may be provided. For example, N1 meets the condition of

$${min}_{N 1} {f}_{1} ( N 1 ) \leq P ,$$

if the N1 not exceed a predefined threshold t1 (if provided), otherwise N1 equal to t1.

In some embodiments, the second expected size N2 may meet the condition of

$${min}_{N 2} {f}_{2} ( N 2 ) \leq r ,$$

where f₂(x) is the function between a data size of a training dataset (for a specific impact factor that affects the model generalization capability, e.g., drops, clutter parameters, scenarios, or synchronization errors) and the positioning accuracy boosting rate, and r is the expected positioning accuracy boosting rate (a default value or indicated by the terminal device 110 or the network device 120). In some embodiments, an upper limit for N1 may be provided. For example, N2 meets the condition of

$${min}_{N 2} {f}_{2} ( N 2 ) \leq r$$

if the N2 does not exceed the predefined threshold t2 (if provided), otherwise N2 equal to t2.

For direct AI/ML positioning and AI/ML assisted positioning, N1 and/or N2 may be specified by the network device 120. In some embodiments, for the AI/ML assisted positioning, an additional third expected size (e.g., N3) of a training dataset required to meet an expected accuracy level for AI/ML assisted positioning. N3 may be reported depending on the output of the AI/ML model.

In some embodiments, for LOS/NLOS identification, N3 may meet the condition of

$${min}_{N 3} {f}_{3} ( N 3 ) \geq i ,$$

where f₃(x) is the function between a data size of a training dataset (for a specific impact factor that affects the model generalization capability, e.g., drops, clutter parameters, scenarios, or synchronization errors) and an expected accuracy level of LOS (or NLOS) identification, and i is the expected identification accuracy (a default value or indicated by the terminal device 110 or the network device 120). For the time/angle estimation, N3 may meet the condition of

$${min}_{N 3} {f}_{4} ( N 3 ) \leq e ,$$

where f₄(x) is the function between number of sample (for a specific impact factor that affects the model generalization capability, e.g., drops, clutter parameters, scenarios, or synchronization errors) and an expected accuracy level of time/angle estimation, and e is the expected time/angle estimation accuracy (a default value or indicated by the terminal device 110 or the network device 120).

In some embodiments, an upper limit for N1 may be provided. For example, N3 meets the condition of

$${min}_{N 3} {f}_{3} ( N 3 ) \geq i$$

if N3 does not exceed the predefined threshold t3 (if provided), otherwise N3 equal to t3.

In some embodiments, the first, second and/or third expected sizes N1, N2 and N3 may be configured for a certain type of impact factor (e.g., for the drops, cluster parameters, scenarios, or network synchronization errors). In some embodiments, the second information may indicate {N1, N2, N3} for the impact factor of drops, {N1, N2, N3} for the impact factor of cluster parameters, {N1, N2, N3} for the impact factor of scenarios, {N1, N2, N3} for the impact factor of network synchronization errors. The N1, N2 and N3 for different types of impact factors may be the same or different.

With the second information, the terminal device 110 may determine whether the first expected size, the second expected size, or the third expected size exceeds a predetermined threshold size. If the first expected size, the second expected size, or the third expected size exceeds a predetermined threshold size, the terminal device 110 may transmit, to the network device 120, the first information related to a training dataset with the predetermined threshold size. If the first expected size, the second expected size, or the third expected size is lower than or equal to the predetermined threshold size, the terminal device 110 may transmit, to the network device 120, first information related to a training dataset with the first expected size, the second expected size, or the third expected size.

In some embodiments, the data size of a training dataset for an impact factor may also be determined by the correlation comparison between the pre-collected training samples from a new environment and priori data. The terminal device 110 may report the missing number of training samples to the network device 120 to collect the training samples if the pre-collected training data is not enough to train or fine-tune the AI/ML model 130 with the required performance.

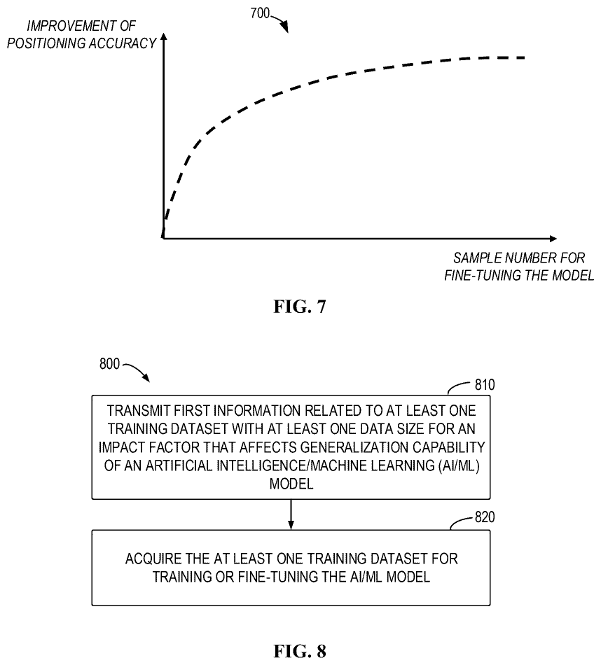

FIG. 8 illustrates a flowchart of a method 800 implemented at a first communication device in accordance with some embodiments of the present disclosure. For the purpose of discussion, the method 800 will be described from the perspective of the first communication device 302 in FIG. 3.

At block 810, the first communication device 302 transmits, to at least one second communication device 304, first information related to at least one training dataset with at least one data size for an impact factor that affects generalization capability of an artificial intelligence/machine learning (AI/ML) model. At block 820, first communication device 302 acquires the at least one training dataset for training or fine-tuning the AI/ML model.

In some embodiments, the impact factor comprises: a drop, a clutter parameter, a scenario where the AI/ML model is implemented, or a network synchronization error.

In some embodiments, the first communication device is a terminal device for training or fine-tuning the AI/ML model, and the at least one second communication device is a network device.

In some embodiments, the first information indicates at least one of the following: the at least one data size of the at least one training dataset to be acquired, the at least one data size corresponding to at least one environment of the impact factor, a data size of an available training dataset at the terminal device, reference signal resource configuration information used by the terminal device to collect a training dataset, or information related to a network synchronization error at the terminal device.

In some embodiments, acquiring the at least one training dataset comprises receiving the at least one training dataset from the network device, or collecting the at least one training dataset based on further reference signal resource configuration information, the further reference signal resource configuration information being determined by the network device based on the first information.

In some embodiments, the impact factor comprises a network synchronization error, and the first information indicates a request for statistical information of the network synchronization error. In some embodiments, acquiring the at least one training dataset comprises receiving, from the network device, the statistical information of the network synchronization error; and generating the at least one training dataset based on the statistical information of the network synchronization error.

In some embodiments, the first information indicates the number of basic training datasets to be acquired and a minimum data size of each basic training dataset. In some embodiments, acquiring the at least one training dataset comprises receiving, from the network device, at least one basic training dataset with the minimum data size indicated by the first information. In some embodiments, the method 800 further comprises training or fine-tuning the AI/ML model based on the at least one received basic training dataset; and in accordance with a determination that the trained or fine-tuned AI/ML model reaches a target accuracy level, transmitting, to the network device, a request to interrupt transmission of remaining basic training datasets.

In some embodiments, the method 800 further comprises: receiving, by the terminal device and from the network device, second information indicating at least one of the following: for the impact factor, a first expected size of a training dataset required to meet an expected positioning accuracy level of the AI/ML model, a second expected size of a training dataset required to meet an expected positioning accuracy boosting rate of the AI/ML model, or a third expected size of a training dataset required to meet an expected accuracy level for AI/ML assisted positioning.

In some embodiments, in the case that the first expected size, the second expected size, or the third expected size exceeds a predetermined threshold size, the at least one data size of the at least one training dataset related to the first information comprises the predetermined threshold size; and in the case that the first expected size, the second expected size, or the third expected size is lower than or equal to the predetermined threshold size, the at least one data size of the at least one training dataset related to the first information comprises the first expected size, the second expected size, or the third expected size.

In some embodiments, the first communication device is a network device for training or fine-tuning the AI/ML model, and the at least one second communication device comprises a plurality of terminal devices for collecting training datasets. In some embodiments, acquiring the at least one training dataset comprises: receiving, from the plurality of terminal devices, a plurality of training datasets or related information for generating the plurality of training datasets.

In some embodiments, the first information indicates a minimum data size of a training dataset to be collected within a specific duration.

In some embodiments, in the case that the plurality of terminal devices are to experience different environments of the impact factor within a plurality of durations, the first information indicates a plurality of minimum data sizes of a plurality of training datasets to be collected and the plurality of durations during which the plurality of training datasets are to be collected, respectively.

In some embodiments, the AI/ML model comprises a direct AI/ML positioning model or an AI/ML assisted positioning model.

FIG. 9 illustrates a flowchart of a method 900 implemented at a second communication in accordance with some embodiments of the present disclosure. For the purpose of discussion, the method 900 will be described from the perspective of the second communication device 304 in FIG. 3.

At block 910, the second communication device 304 receives, from a first communication device, first information related to at least one training dataset with at least one data size for an impact factor that affects generalization capability of an artificial intelligence/machine learning (AI/ML) model. At block 920, the second communication device 304 causes the first communication device to acquire the at least one training dataset for training or fine-tuning the AI/ML model based on the first information.

In some embodiments, the first communication device is a terminal device for training or fine-tuning the AI/ML model, and the second communication device is a network device.

In some embodiments, the first information indicates at least one of the following: the at least one data size of the at least one training dataset to be acquired, the at least one data size corresponding to at least one environment of the impact factor, a data size of an available training dataset at the terminal device, reference signal resource configuration information used by the terminal device to collect a training dataset, information related to a network synchronization error at the terminal device, or the number of basic training datasets to be acquired and a minimum data size of each basic training dataset.

In some embodiments, causing the first communication device to acquire the at least one training dataset comprises: transmitting the at least one training dataset to the terminal device, or allocating, based on the first information, further reference signal resource configuration information for the terminal device to collect the at least one training dataset.

In some embodiments, the impact factor comprises a network synchronization error, and the first information indicates a request for statistical information of the network synchronization error. In some embodiments, causing the first communication device to acquire the at least one training dataset comprises: transmitting, to the terminal device, the statistical information of the network synchronization error for generating the at least one training dataset.

In some embodiments, the first information indicates the number of basic training datasets to be acquired and a minimum data size of each basic training dataset. In some embodiments, causing the first communication device to acquire the at least one training dataset comprises: transmitting, to the terminal device, at least one basic training dataset with the minimum data size indicated by the first information. In some embodiments, the method 900 further comprises receiving, by the network device and from the terminal device, a request to interrupt transmission of remaining basic training datasets; and preventing the remaining basic training datasets to be transmitted to the terminal device.

In some embodiments, the method 900 further comprises: transmitting, to the terminal device, second information indicating at least one of the following: for the impact factor, a first expected size of a training dataset required to meet an expected positioning accuracy level of the AI/ML model, a second expected size of a training dataset required to meet an expected positioning accuracy boosting rate of the AI/ML model, or a third expected size of a training dataset required to meet an expected accuracy level for AI/ML assisted positioning.

In some embodiments, in the case that the first expected size, the second expected size, or the third expected size exceeds a predetermined threshold size, the at least one data size of the at least one training dataset related to the first information related to a training dataset with the predetermined threshold size; and in the case that the first expected size, the second expected size, or the third expected size is lower than or equal to the predetermined threshold size, the at least one data size of the at least one training dataset related to the first information comprises the first expected size, the second expected size, or the third expected size.

In some embodiments, the first communication device is a network device for training or fine-tuning the AI/ML model, and the second communication device is one of a plurality of terminal devices for collecting training datasets. In some embodiments, causing the first communication device to acquire the at least one training dataset comprises: transmitting, to the network device, the at least one training dataset or related information for generating the at least one training dataset.

In some embodiments, the first information indicates a minimum data size of a training dataset to be collected within a specific duration.

In some embodiments, the first information indicates a plurality of minimum data sizes of a plurality of training datasets to be collected and the plurality of durations during which the plurality of training datasets are to be collected, respectively.

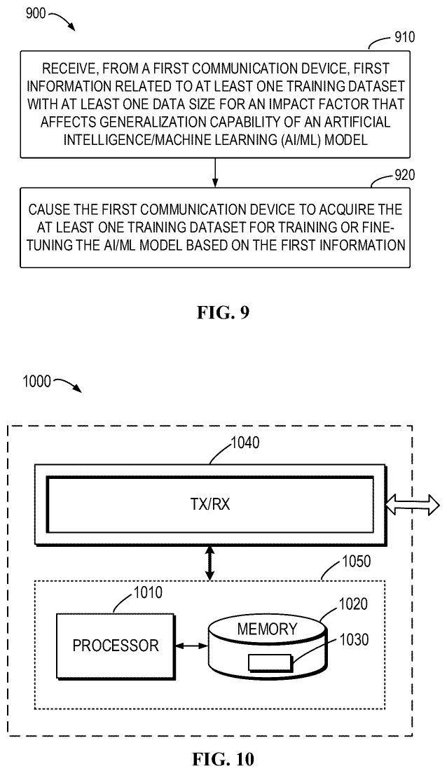

FIG. 10 is a simplified block diagram of a device 1000 that is suitable for implementing embodiments of the present disclosure. The device 1000 can be considered as a further example implementation of any of the devices as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX)/receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 11. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a first communication device comprises a circuitry configured to: transmit, to at least one second communication device, first information related to at least one training dataset with at least one data size for an impact factor that affects generalization capability of an artificial intelligence/machine learning (AI/ML) model; and acquire the at least one training dataset for training or fine-tuning the AI/ML model. According to embodiments of the present disclosure, the circuitry may be configured to perform any of the method implemented by the first communication device as discussed above.

In some embodiments, a second communication device comprises a circuitry configured to: receive, from a first communication device, first information related to at least one training dataset with at least one data size for an impact factor that affects generalization capability of an artificial intelligence/machine learning (AI/ML) model; and cause the first communication device to acquire the at least one training dataset for training or fine-tuning the AI/ML model based on the first information. According to embodiments of the present disclosure, the circuitry may be configured to perform any of the method implemented by the second communication device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a first communication device comprises: a processor configured to cause the first communication device to: transmit, to at least one second communication device, first information related to at least one training dataset with at least one data size for an impact factor that affects generalization capability of an artificial intelligence/machine learning (AI/ML) model; and acquire the at least one training dataset for training or fine-tuning the AI/ML model.

In some embodiments, the impact factor comprises: a drop, a clutter parameter, a scenario where the AI/ML model is implemented, or a network synchronization error.

In some embodiments, the first communication device is a terminal device for training or fine-tuning the AI/ML model, and the at least one second communication device is a network device.

In some embodiments, the first information indicates at least one of the following: the at least one data size of the at least one training dataset to be acquired, the at least one data size corresponding to at least one environment of the impact factor, a data size of an available training dataset at the terminal device, reference signal resource configuration information used by the terminal device to collect a training dataset, information related to a network synchronization error at the terminal device, or the number of basic training datasets to be acquired and a minimum data size of each basic training dataset.

In some embodiments, the processor is further configured to cause the first communication device to acquire the at least one training dataset by: receiving the at least one training dataset from the network device, or collecting the at least one training dataset based on further reference signal resource configuration information, the further reference signal resource configuration information being determined by the network device based on the first information.

In some embodiments, the impact factor comprises a network synchronization error, and the first information indicates a request for statistical information of the network synchronization error; and wherein the processor is further configured to cause the first communication device to acquire the at least one training dataset by: receiving, from the network device, the statistical information of the network synchronization error; and generating the at least one training dataset based on the statistical information of the network synchronization error.

In some embodiments, the first information indicates the number of basic training datasets to be acquired and a minimum data size of each basic training dataset, and wherein the processor is further configured to cause the first communication device to acquire the at least one training dataset by: receiving, from the network device, at least one basic training dataset with the minimum data size indicated by the first information; and wherein the processor is further configured to cause the first communication device to: train or fine-tune the AI/ML model based on the at least one received basic training dataset; and in accordance with a determination that the trained or fine-tuned AI/ML model reaches a target accuracy level, transmit, to the network device, a request to interrupt transmission of remaining basic training datasets.

In some embodiments, the processor is further configured to cause the first communication device to: receive, from the network device, second information indicating at least one of the following: for the impact factor, a first expected size of a training dataset required to meet an expected positioning accuracy level of the AI/ML model, a second expected size of a training dataset required to meet an expected positioning accuracy boosting rate of the AI/ML model, or a third expected size of a training dataset required to meet an expected accuracy level for AI/ML assisted positioning.

In some embodiments, in the case that the first expected size, the second expected size, or the third expected size exceeds a predetermined threshold size, the at least one data size of the at least one training dataset related to the first information comprises the predetermined threshold size; and in the case that the first expected size, the second expected size, or the third expected size is lower than or equal to the predetermined threshold size, the at least one data size of the at least one training dataset related to the first information comprises the first expected size, the second expected size, or the third expected size.

In some embodiments, the first communication device is a network device for training or fine-tuning the AI/ML model, and the at least one second communication device comprises a plurality of terminal devices for collecting training datasets; and wherein the processor is further configured to cause the first communication device to: receive, from the plurality of terminal devices, a plurality of training datasets or related information for generating the plurality of training datasets.

In some embodiments, the first information indicates a minimum data size of a training dataset to be collected within a specific duration.

In some embodiments, in the case that the plurality of terminal devices are to experience different environments of the impact factor within a plurality of durations, transmit, to the plurality of terminal devices, the first information indicates a plurality of minimum data sizes of a plurality of training datasets to be collected and the plurality of durations during which the plurality of training datasets are to be collected, respectively.

In some embodiments, the AI/ML model comprises a direct AI/ML positioning model or an AI/ML assisted positioning model.

In an aspect, a second communication device comprises: a processor configured to cause the first communication device to: receive, from a first communication device, first information related to at least one training dataset with at least one data size for an impact factor that affects generalization capability of an artificial intelligence/machine learning (AI/ML) model; and cause the first communication device to acquire the at least one training dataset for training or fine-tuning the AI/ML model based on the first information.

In some embodiments, the first communication device is a terminal device for training or fine-tuning the AI/ML model, and the second communication device is a network device.

In some embodiments, the first information indicates at least one of the following: the at least one data size of the at least one training dataset to be acquired, the at least one data size corresponding to at least one environment of the impact factor, a data size of an available training dataset at the terminal device, reference signal resource configuration information used by the terminal device to collect a training dataset, information related to a network synchronization error at the terminal device, or the number of basic training datasets to be acquired and a minimum data size of each basic training dataset.

In some embodiments, the processor is further configured to cause the second communication device to cause the first communication device to acquire the at least one training dataset by: transmitting the at least one training dataset to the terminal device, or allocating, based on the first information, further reference signal resource configuration information for the terminal device to collect the at least one training dataset.

In some embodiments, the impact factor comprises a network synchronization error, and the first information indicates a request for statistical information of the network synchronization error; and wherein the processor is further configured to cause the second communication device to cause the first communication device to acquire the at least one training dataset by: transmitting, to the terminal device, the statistical information of the network synchronization error for generating the at least one training dataset.

In some embodiments, the first information indicates the number of basic training datasets to be acquired and a minimum data size of each basic training dataset, and wherein the processor is further configured to cause the second communication device to cause the first communication device to acquire the at least one training dataset by: transmitting, to the terminal device, at least one basic training dataset with the minimum data size indicated by the first information; and wherein the processor is further configured to cause the second communication device to: receive, from the terminal device, a request to interrupt transmission of remaining basic training datasets; and prevent the remaining basic training datasets to be transmitted to the terminal device.

In some embodiments, the processor is further configured to cause the second communication device to: transmit, to the terminal device, second information indicating at least one of the following: for the impact factor, a first expected size of a training dataset required to meet an expected positioning accuracy level of the AI/ML model, a second expected size of a training dataset required to meet an expected positioning accuracy boosting rate of the AI/ML model, or a third expected size of a training dataset required to meet an expected accuracy level for AI/ML assisted positioning.

In some embodiments, in the case that the first expected size, the second expected size, or the third expected size exceeds a predetermined threshold size, the at least one data size of the at least one training dataset related to the first information related to a training dataset with the predetermined threshold size; and in the case that the first expected size, the second expected size, or the third expected size is lower than or equal to the predetermined threshold size, the at least one data size of the at least one training dataset related to the first information comprises the first expected size, the second expected size, or the third expected size.

In some embodiments, the first communication device is a network device for training or fine-tuning the AI/ML model, and the second communication device is one of a plurality of terminal devices for collecting training datasets; and wherein the processor is further configured to cause the second communication device to cause the first communication device to acquire the at least one training dataset by: transmitting, to the network device, the at least one training dataset or related information for generating the at least one training dataset.

In some embodiments, the first information indicates a minimum data size of a training dataset to be collected within a specific duration.

In some embodiments, the first information indicates a plurality of minimum data sizes of a plurality of training datasets to be collected and the plurality of durations during which the plurality of training datasets are to be collected, respectively.

In an aspect, a communication method comprises: transmitting, by a first communication device and to at least one second communication device, first information related to at least one training dataset with at least one data size for an impact factor that affects generalization capability of an artificial intelligence/machine learning (AI/ML) model; and acquiring the at least one training dataset for training or fine-tuning the AI/ML model.

In an aspect, a communication method comprises: receiving, by a second communication device and from a first communication device, first information related to at least one training dataset with at least one data size for an impact factor that affects generalization capability of an artificial intelligence/machine learning (AI/ML) model;

and causing the first communication device to acquire the at least one training dataset for training or fine-tuning the AI/ML model based on the first information.

In an aspect, a first communication device comprises: at least one processor; and at least one memory coupled to the at least one processor and storing instructions thereon, the instructions, when executed by the at least one processor, causing the device to perform the method implemented by the first communication device discussed above.

In an aspect, a second communication device comprises: at least one processor; and at least one memory coupled to the at least one processor and storing instructions thereon, the instructions, when executed by the at least one processor, causing the device to perform the method implemented by the second communication device discussed above.

In an aspect, a computer readable medium having instructions stored thereon, the instructions, when executed on at least one processor, causing the at least one processor to perform the method implemented by the first communication device discussed above.

In an aspect, a computer readable medium having instructions stored thereon, the instructions, when executed on at least one processor, causing the at least one processor to perform the method implemented by the second communication device discussed above.

In an aspect, a computer program comprising instructions, the instructions, when executed on at least one processor, causing the at least one processor to perform the method implemented by the first communication device discussed above.

In an aspect, a computer program comprising instructions, the instructions, when executed on at least one processor, causing the at least one processor to perform the method implemented by the second communication device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 8-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first communication device comprising:
a processor configured to cause the first communication device to:
transmit, to at least one second communication device, first information related to at least one training dataset with at least one data size for an impact factor that affects generalization capability of an artificial intelligence/machine learning (AI/ML) model; and
acquire the at least one training dataset for training or fine-tuning the AI/ML model.

2. The device of claim 1, wherein the first communication device is a terminal device for training or fine-tuning the AI/ML model, and the at least one second communication device is a network device.

3. The device of claim 2, wherein the first information indicates at least one of the following:
the at least one data size of the at least one training dataset to be acquired, the at least one data size corresponding to at least one environment of the impact factor,
a data size of an available training dataset at the terminal device,
reference signal resource configuration information used by the terminal device to collect a training dataset, or
information related to a network synchronization error at the terminal device.

4. The device of claim 2, wherein the processor is further configured to cause the first communication device to acquire the at least one training dataset by:
receiving the at least one training dataset from the network device, or
collecting the at least one training dataset based on further reference signal resource configuration information, the further reference signal resource configuration information being determined by the network device based on the first information.

5. The device of claim 2, wherein the impact factor comprises a network synchronization error, and the first information indicates a request for statistical information of the network synchronization error; and
wherein the processor is further configured to cause the first communication device to acquire the at least one training dataset by:
receiving, from the network device, the statistical information of the network synchronization error; and
generating the at least one training dataset based on the statistical information of the network synchronization error.

6. The device of claim 2, wherein the first information indicates the number of basic training datasets to be acquired and a minimum data size of each basic training dataset, and wherein the processor is further configured to cause the first communication device to acquire the at least one training dataset by:
receiving, from the network device, at least one basic training dataset with the minimum data size indicated by the first information; and
wherein the processor is further configured to cause the first communication device to:
train or fine-tune the AI/ML model based on the at least one received basic training dataset; and
in accordance with a determination that the trained or fine-tuned AI/ML model reaches a target accuracy level, transmit, to the network device, a request to interrupt transmission of remaining basic training datasets.

7. The device of claim 1, wherein the first communication device is a network device for training or fine-tuning the AI/ML model, and the at least one second communication device comprises a plurality of terminal devices for collecting training datasets; and
wherein the processor is further configured to cause the first communication device to: receive, from the plurality of terminal devices, a plurality of training datasets or related information for generating the plurality of training datasets.

8. The device of claim 2, wherein the processor is further configured to cause the first communication device to:
receive, from the network device, second information indicating at least one of the following: for the impact factor,
a first expected size of a training dataset required to meet an expected positioning accuracy level of the AI/ML model,
a second expected size of a training dataset required to meet an expected positioning accuracy boosting rate of the AI/ML model, or
a third expected size of a training dataset required to meet an expected accuracy level for AI/ML assisted positioning.

9. The device of claim 8, wherein in the case that the first expected size, the second expected size, or the third expected size exceeds a predetermined threshold size, the at least one data size of the at least one training dataset related to the first information comprises the predetermined threshold size; and
in the case that the first expected size, the second expected size, or the third expected size is lower than or equal to the predetermined threshold size, the at least one data size of the at least one training dataset related to the first information comprises the first expected size, the second expected size, or the third expected size.

10. A second communication device comprising:
a processor configured to cause the first communication device to:
receive, from a first communication device, first information related to at least one training dataset with at least one data size for an impact factor that affects generalization capability of an artificial intelligence/machine learning (AI/ML) model; and
cause the first communication device to acquire the at least one training dataset for training or fine-tuning the AI/ML model based on the first information.

11. The device of claim 10, wherein the first communication device is a terminal device for training or fine-tuning the AI/ML model, and the second communication device is a network device.

12. The device of claim 11, wherein the first information indicates at least one of the following:
the at least one data size of the at least one training dataset to be acquired, the at least one data size corresponding to at least one environment of the impact factor,
a data size of an available training dataset at the terminal device,
reference signal resource configuration information used by the terminal device to collect a training dataset, or
information related to a network synchronization error at the terminal device.

13. The device of claim 11, wherein the processor is further configured to cause the second communication device to cause the first communication device to acquire the at least one training dataset by:
transmitting the at least one training dataset to the terminal device, or
allocating, based on the first information, further reference signal resource configuration information for the terminal device to collect the at least one training dataset.

14. The device of claim 11, wherein the impact factor comprises a network synchronization error, and the first information indicates a request for statistical information of the network synchronization error; and
wherein the processor is further configured to cause the second communication device to cause the first communication device to acquire the at least one training dataset by:
transmitting, to the terminal device, the statistical information of the network synchronization error for generating the at least one training dataset.

15. The device of claim 11, wherein the first information indicates the number of basic training datasets to be acquired and a minimum data size of each basic training dataset, and wherein the processor is further configured to cause the second communication device to cause the first communication device to acquire the at least one training dataset by:
transmitting, to the terminal device, at least one basic training dataset with the minimum data size indicated by the first information; and
wherein the processor is further configured to cause the second communication device to:
receive, from the terminal device, a request to interrupt transmission of remaining basic training datasets; and
prevent the remaining basic training datasets to be transmitted to the terminal device.

16. The device of claim 11, wherein the processor is further configured to cause the second communication device to:
transmit, to the terminal device, second information indicating at least one of the following: for the impact factor,
a first expected size of a training dataset required to meet an expected positioning accuracy level of the AI/ML model,
a second expected size of a training dataset required to meet an expected positioning accuracy boosting rate of the AI/ML model, or
a third expected size of a training dataset required to meet an expected accuracy level for AI/ML assisted positioning.

17. The device of claim 16, wherein in the case that the first expected size, the second expected size, or the third expected size exceeds a predetermined threshold size, the at least one data size of the at least one training dataset related to the first information comprises the predetermined threshold size; and
in the case that the first expected size, the second expected size, or the third expected size is lower than or equal to the predetermined threshold size, the at least one data size of the at least one training dataset related to the first information comprises the first expected size, the second expected size, or the third expected size.

18. A communication method comprising:
transmitting, by a first communication device and to at least one second communication device, first information related to at least one training dataset with at least one data size for an impact factor that affects generalization capability of an artificial intelligence/machine learning (AI/ML) model; and
acquiring the at least one training dataset for training or fine-tuning the AI/ML model.

19. A communication method comprising:
receiving, by a second communication device and from a first communication device, first information related to at least one training dataset with at least one data size for an impact factor that affects generalization capability of an artificial intelligence/machine learning (AI/ML) model; and
causing the first communication device to acquire the at least one training dataset for training or fine-tuning the AI/ML model based on the first information.

20. A computer readable medium having instructions stored thereon, the instructions, when executed on at least one processor, causing the at least one processor to perform the method according to claim 18 or the method according to claim 19.
